(19) United States
(12) Patent Application Publication
(10) Pub. No.: US 2026/0089646 A1
(43) Pub. Date: Mar. 26, 2026

(54) UPLINK TRANSMIT POWER LIMIT ADJUSTMENT FOR ACK-CARRYING TRAFFIC

(71) Applicant: Apple Inc., Cupertino, CA (US)

(72) Inventors: Lorenzo BERTIZZOLO, San Francisco, CA (US); Prashant H. VASHI, San Jose, CA (US)

(21) Appl. No.: 19/277,749

(22) Filed: Jul. 23, 2025

Related U.S. Application Data
(60) Provisional application No. 63/697,162, filed on Sep. 20, 2024.

(51) Int. Cl. H04W 52/14

(52) U.S. Cl. CPC H04W 52/146

(57) ABSTRACT

The described embodiments relate to wireless communications, including methods and apparatus to adjust a transmit power limit for uplink cellular wireless transmission by a wireless device based at least in part on inclusion or exclusion of an acknowledgement (ACK) in the uplink cellular wireless transmission. The wireless device determines whether adverse uplink radio conditions are impacting downlink performance, such as loss of uplink ACK messages causing downlink data stalls. The wireless device excludes at least one non-regulatory device performance transmit power limit while including one or more applicable regulatory transmit power limits when determining a maximum transmit power limit for transmissions that include uplink ACK messages.

### CROSS-REFERENCE TO RELATED APPLICATIONS

The present application claims the benefit of U.S. Provisional Application No. 63/697,162, entitled “UPLINK TRANSMIT POWER LIMIT ADJUSTMENT FOR ACK-CARRYING TRAFFIC,” filed Sep. 20, 2024, the content of which is incorporated by reference herein in its entirety for all purposes.

### FIELD

The described embodiments relate to wireless communications, including methods and apparatus to adjust a transmit power limit for uplink cellular wireless transmission by a wireless device based at least in part on inclusion or exclusion of an acknowledgement (ACK) in the uplink cellular wireless transmission.

### BACKGROUND

Wireless devices include logic to determine appropriate transmit levels for radio frequency signals transmitted by the wireless device. Multiple factors can influence a maximum transmit power level that a wireless device can use under various circumstances. For example, regulatory bodies in different geographic areas can mandate radio frequency (RF) safety rules and/or guidelines that limit exposure by human bodies (or specific parts thereof) to RF radiation by radio transmitters. Manufacturers of cellular wireless devices can be required to comply with regulations that restrict a rate of RF energy that may be absorbed by a human body part, usually expressed by an amount of power, i.e., energy per unit time, (e.g., Watts) per unit weight (e.g., kilograms). A regulatory body, such as the Federal Communications Commission (FCC) in a geographic region, such as the United States, can mandate that a cellular wireless device prove compliance with an established regulation regarding specific absorption rate (SAR) limits. Cellular wireless standards organizations can also provide guidance regarding power limits for wireless devices that use different radio access technologies (RATs) and transmit in various RF bands.

In addition to regulatory requirements that limit RF transmissions, a wireless device can include its own limitations, such as based on hardware capability and/or based on balancing power consumption by various functions of the wireless device. In some cases downlink communication from a wireless network to a wireless device can be limited by poor performance in uplink communication from the wireless device to a wireless network, particularly for critical uplink messages, such as acknowledgements indicating receipt by the wireless device of downlink data. There is a need to adapt transmission power levels of critical uplink messages, while maintaining compliance with regulatory limits.

### SUMMARY

The described embodiments relate to wireless communications, including methods and apparatus to adjust a transmit power limit for uplink cellular wireless transmission by a wireless device based at least in part on inclusion or exclusion of an acknowledgement (ACK) in the uplink cellular wireless transmission. The wireless device can determine whether the wireless device is encountering an adverse uplink radio condition that is impacting downlink data performance, e.g., lower downlink data throughput than expected given downlink radio performance, repeated downlink data retransmissions, and/or elevated levels of data discards. Downlink data stalls, where data is delayed or repeatedly sent, and/or an increase downlink data discards, e.g., real-time data dropped at the wireless network transmitter due to extended delays in transmission to the wireless device can be strongly correlated with poor uplink radio performance that can result in a high uplink block error rate (BLER). Loss of uplink ACK messages sent by the wireless device to the wireless network indicating receipt of downlink data can result in downlink data stalls and retransmissions. Uplink transmit power levels are limited by multiple factors that can include both regulatory and standardized constraints as well as device-dependent constraints. In some embodiments, the wireless device determines an uplink transmit power limit for one or more uplink transmissions sent during a future time interval based on whether the one or more uplink transmissions include one or more uplink ACKs corresponding to received downlink data. Actual uplink transmit power levels by the wireless device can vary for different time intervals and can be determined based on an uplink transmit power limit that is determined based on at least one regulatory power limit and excluding a device performance power limit for transmit time intervals that include one or more uplink ACKs corresponding to received downlink data. The uplink transmit power limit can also be determined based on both the at least one regulatory power limit and the device performance power limit for transmit time intervals that do not include an uplink ACK corresponding to downlink data. The wireless device can configure a cellular wireless transceiver, for each transmit time interval, in accordance with a determined uplink transmit power limit.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to adapt communication parameters for a wireless device, according to some embodiments.

FIG. 2 illustrates a block diagram of a more detailed view of exemplary components of a wireless device of the system of FIG. 1, according to some embodiments.

FIG. 3 illustrates a block diagram of exemplary modules of a wireless device used for determining an uplink transmit power limit, according to some embodiments.

FIG. 4 illustrates a diagram of adaptive uplink transmit power limits based on multiple factors including inclusion or exclusion of acknowledgements (ACKs) during transmit time intervals, according to some embodiments.

FIG. 5 illustrates a flow diagram of an exemplary technique to determine an uplink transmit power limit for a wireless device, according to some embodiments.

FIG. 6 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

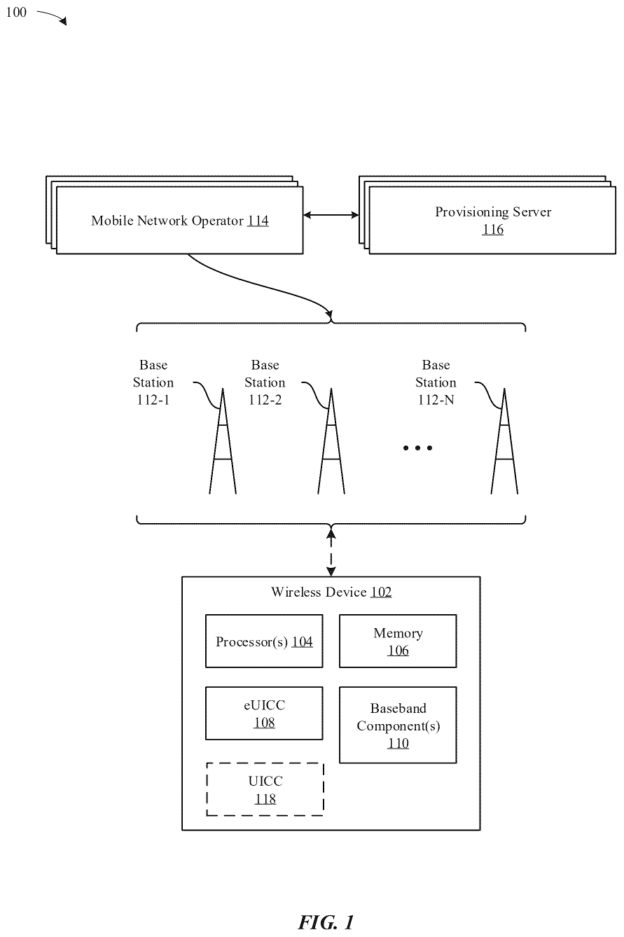

These and other embodiments are discussed below with reference to FIGS. 1 through 6; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, ii) a group of base stations 112-1 to 112-N, which are managed by different Mobile Network Operators (MNOs) 114, and iii) a set of provisioning servers 116 that are in communication with the MNOs 114. The wireless device 102 can represent a mobile computing device (e.g., a phone, a tablet, a peripheral device, etc.), the base stations 112-1 to 112-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUS)). The MNOs 114 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more base stations 112.

As shown in FIG. 1, the wireless device 102 can include processing circuitry, which can include one or more processors 104 and a memory 106, an embedded Universal Integrated Circuit Card (eUICC) 108, and/or integrated UICC (iUICC) (not shown) and baseband component 110 used for transmission and reception of cellular wireless radio frequency signals. In some embodiments, the wireless device 102 can include one or more universal integrated circuit cards (UICCs) 118, also referred to as physical SIM cards, each UICC 118 including a SIM, in addition to or in place of the eUICC 108 providing one or more electronic SIMs (eSIMs) and/or an iUICC providing one or more eSIMs. A wireless device 102 that includes multiple active (enabled) SIMs and/or eSIMs can be referred to generally herein as a multi-SIM/eSIM wireless device. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, baseband component 110, and UICC 118) can be arranged and combined in any number of configurations.

The eUICC 108 can be configured to store multiple eSIMs for accessing services offered by one or more different MNOs 114 via communication through base stations 112-1 to 112-N. To be able to access services provided by the MNOs, one or more eSIMs can be provisioned to the eUICC 108 of the wireless device 102. The wireless device 102 can include wireless circuitry, including the baseband component 110 and at least one transmitter/receiver, also referred to as a transceiver. In some embodiments, the wireless device 102 includes two or more transceivers.

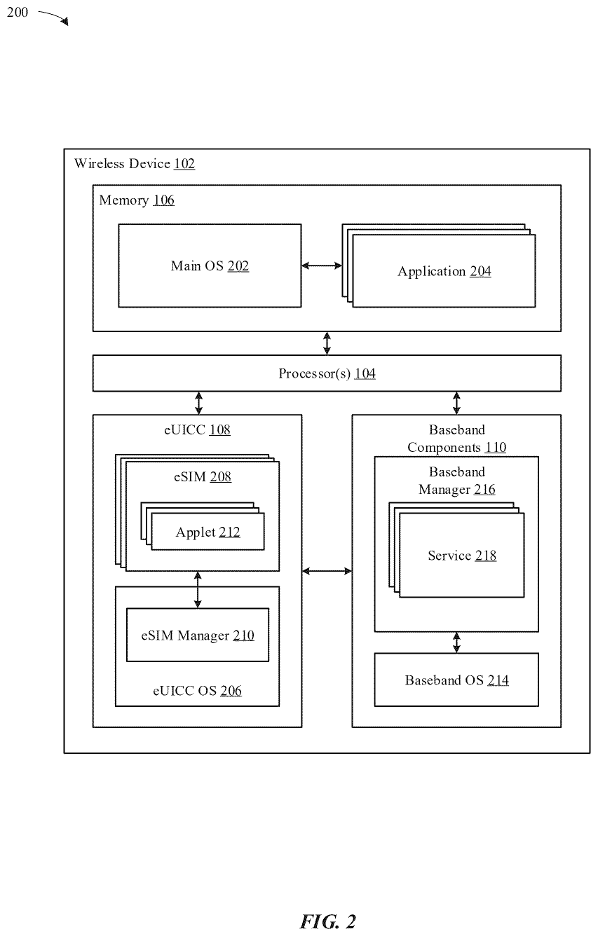

FIG. 2 illustrates a block diagram 200 of a more detailed view of exemplary components of a wireless device 102 of the system 100 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the wireless device 102, e.g., reduced power modes, as well as of the wireless device 102 as a whole, e.g., mobility states, activity/inactivity states. The wireless device 102 further includes an eUICC 108 that can be configured to implement an eUICC OS 206 to manage the hardware resources of the eUICC 108 (e.g., a processor and a memory embedded in the eUICC 108). The eUICC OS 206 can also be configured to manage eSIMs 208 that are stored by the eUICC 108, e.g., by enabling, disabling, modifying, updating, or otherwise performing management of the eSIMs 208 within the eUICC 108 and providing the baseband component 110 with access to the eSIMs 208 to provide access to wireless services for the wireless device 102. The eUICC OS 206 can include an eSIM manager 210, which can perform management functions for various eSIMs 208. Each eSIM 208 can include a number of applets 212 that define the manner in which the eSIM 208 operates. For example, one or more of the applets 212, when implemented by the baseband component 110 and the eUICC 108, can be configured to enable the wireless device 102 to communicate with an MNO 114 and provide useful features (e.g., phone calls and internet) to a user of the wireless device 102.

The baseband component 110 of the wireless device 102 can include a baseband OS 214 that is configured to manage hardware resources of the baseband component 110 (e.g., a processor, a memory, different radio components, etc.). The baseband component 110 (or a portion thereof) can also be referred to as a baseband component, a wireless baseband component, a baseband wireless processor, a cellular baseband component, a cellular component, and the like. According to some embodiments, the baseband component 110 can implement a baseband manager 216 that is configured to interface with the eUICC 108 to establish a secure channel with a provisioning server 116 and obtain information (such as eSIM data) from the provisioning server 116 for purposes of managing eSIMs 208. The baseband manager 216 can be configured to implement services 218, which represent a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108.

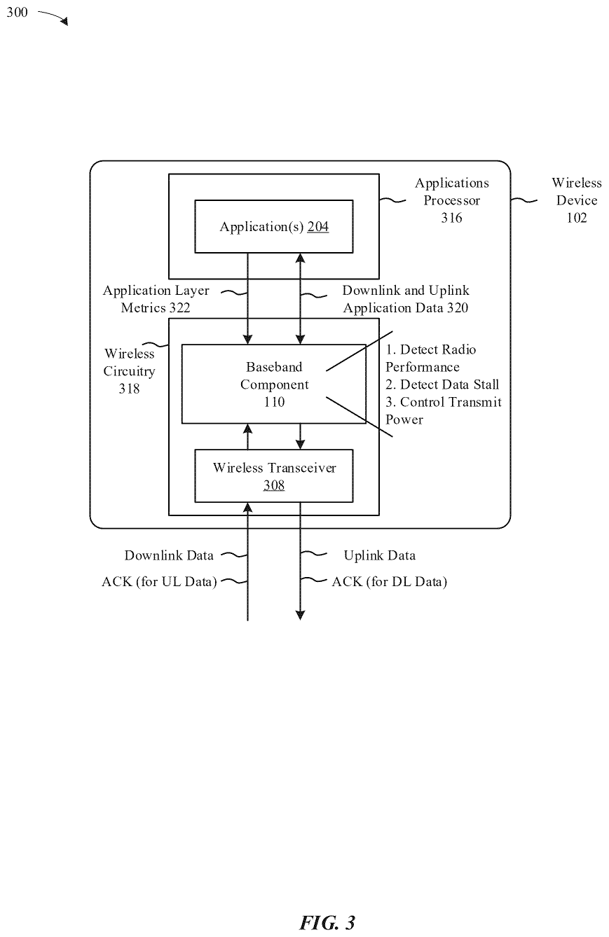

FIG. 3 illustrates a block diagram 300 of components of an exemplary wireless device 102 configurable for adaptive determination and use of uplink transmit power limits for a cellular wireless transmitter of the wireless device 102. The wireless device 102 includes an applications processor 316, which can be one of the processors 104 shown in the wireless device 102 of FIG. 2. The applications processor 316 can execute instructions for one or more applications 204 resident on the wireless device 102 that can generate downlink data application data 320 and consume uplink application data 320 communicated via wireless radio link transmissions between the wireless device 102 and a base station 112 of a cellular wireless network. In some embodiments, the applications processor 316 tracks one or more application layer metrics 322 and provides information regarding the application layer metrics 322 for one or more applications to the baseband component 110. In some embodiments, application layer metrics 322 can provide information regarding application layer latency and/or missing data packets ascertained at the application layer to the baseband component 110 when evaluating performance of wireless data throughput.

The wireless device 102 includes wireless circuitry 318, e.g., a wireless transceiver 308, which can include components to convert uplink data and uplink control information, which can include one or more acknowledgement (ACK) messages responsive to received downlink data, into uplink transmitted radio frequency signals for cellular wireless transmission by the wireless device 102. The wireless circuitry 318 also receives downlink radio frequency signals to process and provide to the baseband component 110, where the downlink radio frequency signals can include downlink data and downlink control information, which can include one or more AKC messages responsive to uplink data sent by the wireless device 102 to a base station 112 of a cellular wireless network. The wireless transceiver 308 can include one or more wireless transmitters and one or more wireless receivers connected to one or more antennas. The wireless transceiver receives one or more control signals (in addition to data) from the baseband component 110, where at least one or more control signals can control transmit power levels for the wireless transceiver 308 to use for uplink transmissions. In some embodiments, the baseband component 110 determines an upper limit for one or more uplink transmissions to occur during a transmit time interval, such as a frame, sub-frame, time slot, or the like, based on a combination of one or more regulatory transmit power limits and/or one or more non-regulatory transmit power limits. Exemplary regulatory transmit power limits can include transmit power limits based on mandates from governmental regulatory agencies, e.g., based on a specific absorption rate (SAR) limit on radiated radio frequency energy, and/or transmit power limits required for compliance with various wireless communications standards, such as for radio frequency in-band emissions and out-of-band, e.g., adjacent band, emissions to control how much transmit power a given wireless device transmits to limit interference with other wireless devices. Exemplary non-regulatory transmit power limits can be device-dependent and/or manufacturer-dependent, such as transmit power limits due to hardware capabilities of the wireless device or transmit power limits due to balancing power consumption requirements for multiple components and/or processes that use a shared power source, e.g., a battery of the wireless device.

A wireless device 102 can be required to comply with SAR limit regulations mandated by various regulatory bodies in different geographic regions, such as the Federal Communications Commission (FCC) in the United States, where the SAR limit ensures that an average amount of radiated radio frequency energy per unit time (power) over various time windows does not exceed certain limits. SAR limits can be specified for different radio frequency technologies, e.g., fourth generation (4G) long term evolution (LTE), fifth generation (5G) new radio (NR), Bluetooth, Wi-Fi, etc. SAR limits can also vary based on a range of radio frequencies used, and amount of radio frequency bandwidth used, a particular wireless device transmission port, etc. Furthermore, SAR limits have been standardized for different positions of a transmitting wireless device 102 relative to a user's human body or portions thereof. In particular, there exist different SAR limits for a head-adjacent position, for a body-adjacent position, for a body-extremity-adjacent position, and for a free space position. SAR limits are most restrictive for head-adjacent positions and least restrictive for free space positioning. A wireless device 102 can determine to use a transmit power level for a transmit time interval that is based at least in part on satisfying a SAR limit, which can limit an average amount of transmit power transfer over a regulatory averaging time window that includes the transmit time interval. The instantaneous transmit power level for an individual transmit time interval can exceed the SAR limit; however, the SAR limit must be met for a regulatory defined averaging time window, which spans a time period significantly longer than the individual transmit time interval.

A wireless device 102 can also be required to comply with regulations established in wireless communication documents drafted and published by wireless communication standards organizations, such as the Third Generation Partnership Project (3GPP) and the like. A wireless device can be required to be certified to comply with one or more wireless communication standards in order to be sold or to be marked with a compliance indication in a geographic region. Wireless communication standards can restrict maximum transmit power levels to ensure fair access to radio frequency bands while limiting interference among multiple wireless devices that use the same radio frequency band. In addition, wireless communication standards can restrict the transmission levels of a wireless device to control an amount of interference into adjacent radio frequency bands.

The wireless device 102 can also restrict transmit power levels based on various non-regulatory device-dependent criteria. Transmitter hardware, e.g., amplifiers, antennas, etc., of the wireless transceiver 308 can impose transmit power limits by design. In addition, the applications processor 316 and/or the baseband component 110 can be configured to use a limited power budget of the wireless device intelligently to balance performance, e.g., data throughput, data processing, etc., with wireless transmission. Furthermore, the applications processor 316 and/or the baseband component 110 can be configured to manage coexistence interference between cellular wireless transmissions by the wireless transceiver 308 and wireless signal reception by additional wireless hardware of the wireless device 102, e.g., for wireless local area network (Wi-Fi) communication and/or wireless personal area network (Bluetooth) communication.

In some embodiments, the baseband component 110 can monitor cellular wireless radio performance, e.g., downlink cellular performance metrics, such as signal strength, signal quality, path loss, bit error rate (BER), block error rate (BLER), and uplink cellular performance metrics, such as based on reception of acknowledgement (ACK) messages from the base station 112 of a cellular wireless network responsive to uplink data transmissions. In some embodiments, the baseband component 110 and/or the applications processor 316 can monitor downlink data performance metrics, e.g., to detect downlink data stalls at the wireless device 102 and/or an elevated rate of downlink data discards by the base station 112. The downlink data can be stalled based on loss or corruption of uplink ACK messages sent to the base station 112 of the cellular wireless network by the wireless device 102 responsive to receipt of downlink data from the base station 112. The base station 112 can conclude that downlink data has been lost or incorrectly received based on an absence of the uplink ACK messages and can re-send downlink data (which reduces an effective downlink data throughput rate) and/or can discard downlink data (such as for real-time data transmissions when delayed too long at the base station 112). In some embodiments, the wireless device 102 determines that downlink radio conditions satisfy downlink performance requirements, e.g., for signal strength and/or signal quality, while uplink radio conditions are likely not satisfying uplink performance requirements. The wireless device 102 can infer uplink radio conditions indirectly in some cases, based on downlink ACK messages received from the base station 112 responsive to uplink data messages sent to the base station 112 by the wireless device 102. When problematic radio link conditions are observed that indicate that downlink data performance is being impacted by uplink radio link conditions, the wireless device 102 can temporarily waive use of one or more non-regulatory transmit power limits for uplink transmissions that include ACK messages responsive to downlink data. In some embodiments, the one or more non-regulatory transmit power limits can be restricting a transmit power level usable by the wireless device 102 for an uplink transmission that includes one or more ACK messages during a transmit time interval. In some embodiments, waiving the one or more non-regulatory transmit power limits the uplink transmission during the transmit time interval can improve reliability of reception of the uplink transmission that includes the one or more ACK messages, which in turn can impact downlink performance as discussed herein.

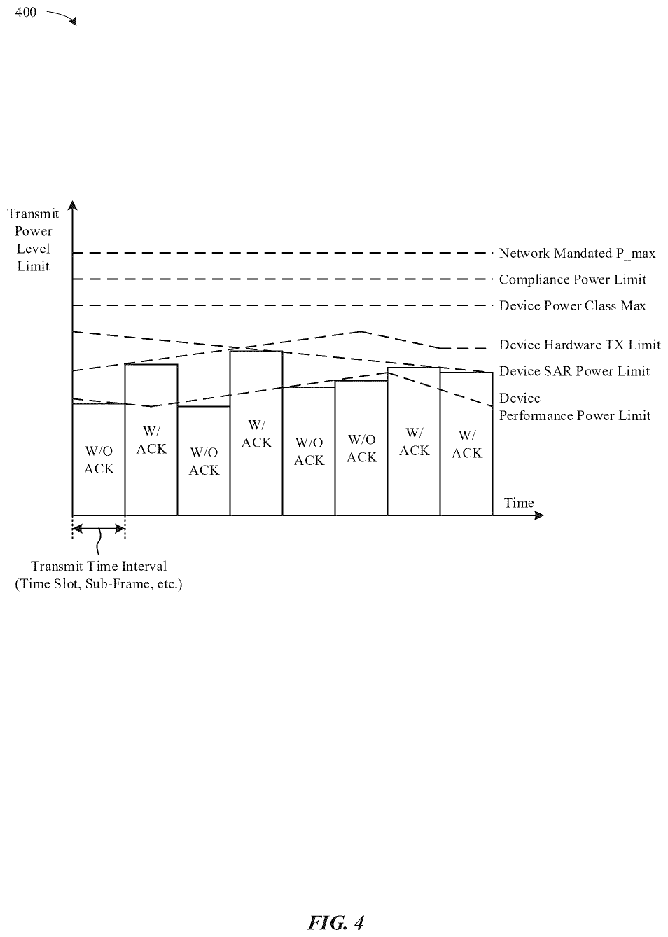

FIG. 4 illustrates a diagram 400 of adaptive uplink transmit power limits based on multiple factors including inclusion or exclusion of acknowledgements (ACKs) during transmit time intervals. A wireless device 102 can comply with one or more regulatory and standardized constraints for transmissions during any transmit time interval. Exemplary transmit time intervals include frames, sub-frames, time-slots, etc. The diagram 400 illustrates several exemplary regulatory and standardized transmit power limits, including i) a network mandated uplink transmit power limit P_max for the wireless device 102, which can be specified to the wireless device 102 by the base station 112 of the cellular wireless network, ii) a standards-specific in-band and out-of-band transmit compliance power limit, iii) a transmit maximum based on a device power class of the wireless device 102, and iv) a device-determined instantaneous transmit power limit based on a time-window averaging SAR transmit power limit. Note that a regulatory SAR transmit power limit is required to be satisfied over an averaging time period that can be significantly longer than a single transmit time interval. The device SAR power limit illustrated represents a device-derived, dynamically determined transmit power limit calculated to enforce SAR compliance with a regulatory transmit power limit over a regulatory SAR time window. The instantaneous transmit power level for an individual transmit time interval must satisfy the device-derived SAR limit but may exceed the corresponding regulatory SAR transmit power limit, which applies to a longer averaging time window. Each of the regulatory and standardized transmit power limits must be complied with by the wireless device 102. The diagram 400 further illustrates two exemplary device-dependent non-regulatory transmit power limits: v) a device hardware transmit power limit based on the components and configuration of the wireless circuitry 318 of the wireless device 102 and vi) a device performance transmit power limit, which can be used to manage transmit power levels to conserve power budget, limit power consumption by the wireless circuitry 318, and balance power consumption for various components and/or processes executing on the wireless device 102. The former hardware based transmit power limit will necessarily be met; however, the latter firmware based device performance power limit can be selectively waived when the wireless device 102 detects problematic uplink radio link conditions impacting downlink data performance. In particular, uplink data transmissions that include information and have critical impact on downlink performance, such as uplink ACK messages, can be allowed to not comply with the device performance power limit when adverse radio link conditions are detected. For a transmit time interval that does not include a transmission with an uplink ACK message, the overall transmit power level limit for uplink transmissions during the transmit time interval can comply with the device performance power limit (and with all other applicable transmit power limits). For a transmit time interval that includes a transmission with an uplink ACK message, the overall transmit power level limit for uplink transmissions during the transmit time interval need not comply with the device performance power limit, but does comply with all other applicable transmit power limits. The overall transmit power level limit for each transmit time interval sets a maximum transmit power level allowed for uplink transmissions during the transmit time interval, and the wireless device 102 transmits in accordance with the determined maximum transmit power level.

In some embodiments, for 4G long term evolution (LTE) physical layer transmissions and for 5G new radio (NR) physical layer transmissions, both a physical uplink control channel (PUCCH) logical channel and a physical uplink shared control channel (PUSCH) logical channel can carry uplink ACK messages. The determined maximum transmit power level can apply to ACK-carrying traffic in the PUCCH and the PUSCH logical channels. Based on downlink traffic, physical layer firmware operable in the baseband component 110 has knowledge of which transmit time intervals will include ACK messages in accordance with applicable wireless communication standards protocols. In some embodiments, the physical layer firmware selectively allows uplink transmit power to be boosted for uplink transmissions that include ACK messages by waiving a device performance power limit determined for the uplink transmissions.

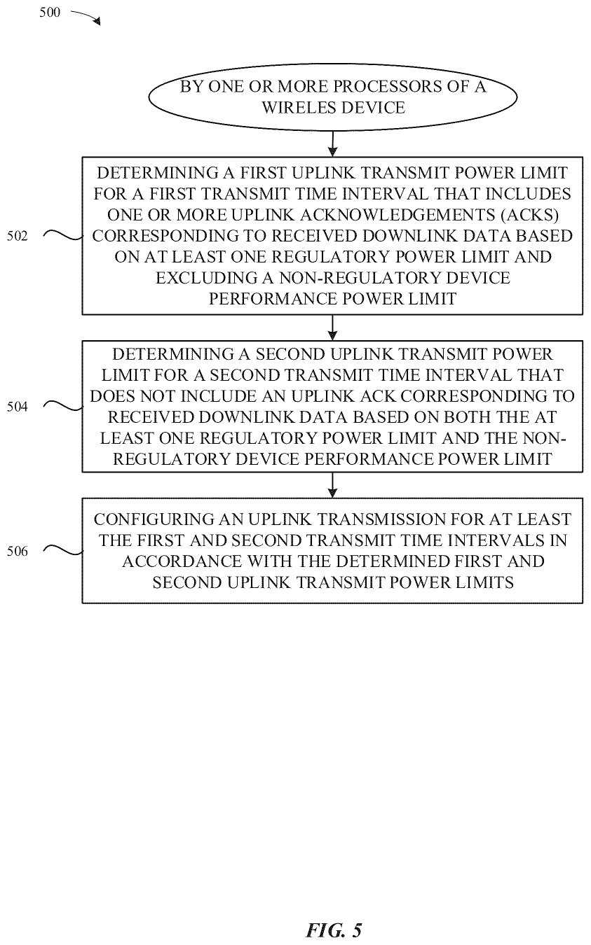

FIG. 5 illustrates a flow diagram 500 of an exemplary technique performed by one or more processors to determine an uplink transmit power limit. At 502, the one or more processors determine a first uplink transmit power limit for a first transmit time interval that includes one or more uplink ACKs corresponding to received downlink data based on at least one regulatory power limit and excluding a non-regulatory device performance power limit. At 504, the one or more processors determine a second uplink transmit power limit for a second transmit time interval that does not include an uplink ACK corresponding to received downlink data based on both the at least one regulatory power limit and the non-regulatory device performance power limit. At 506, the one or more processors configure an uplink transmission for at least the first and second transmit time intervals in accordance with the determined first and second uplink transmit power limits.

In some embodiments, the method performed by the one or more processors further includes determining an adverse uplink radio condition is impacting downlink data performance, wherein determination of the first and second uplink transmit power limits and configuration of the uplink transmission in accordance with the determined first and second uplink transmit power limits occurs responsive to determination of the adverse uplink radio condition. In some embodiments, the method performed by the one or more processors further includes responsive to determination that the adverse uplink radio condition is no longer impacting downlink data performance, determining a third uplink transmit power limit for a third transmit time interval based on both the at least one regulatory power limit and the non-regulatory device performance power limit independent of whether the third transmit time interval includes uplink ACKs corresponding to received downlink data. In some embodiments, determining the adverse uplink radio condition is impacting downlink data performance includes detecting uplink performance does not satisfy an uplink performance threshold and downlink performance satisfies a downlink performance threshold. In some embodiments, the uplink performance does not satisfy the uplink performance threshold when an uplink block error rate (BLER) exceeds an uplink BLER threshold. In some embodiments, determining the adverse uplink radio condition is impacting downlink data performance further includes detecting operation in a far cell condition. In some embodiments, determining the adverse uplink radio condition is impacting downlink data performance further includes detecting a radio link path loss value exceeding a radio link path loss threshold. In some embodiments, determining the adverse uplink radio condition is impacting downlink data performance further includes detecting uplink power limited transmission. In some embodiments, determining the adverse uplink radio condition is impacting downlink data performance further includes detecting operation using a radio frequency band having a specific absorption rate (SAR) limit below a SAR threshold. In some embodiments, determination of the first uplink transmit power limit and the second uplink transmit power limit is further based on a device transmit hardware limit. In some embodiments, determination of the first uplink transmit power limit and the second uplink transmit power limit is further based on a specific absorption rate (SAR) limit. In some embodiments, determination of the first uplink transmit power limit and the second uplink transmit power limit is further based on a cellular wireless network specified transmit power limit.

### Representative Exemplary Apparatus

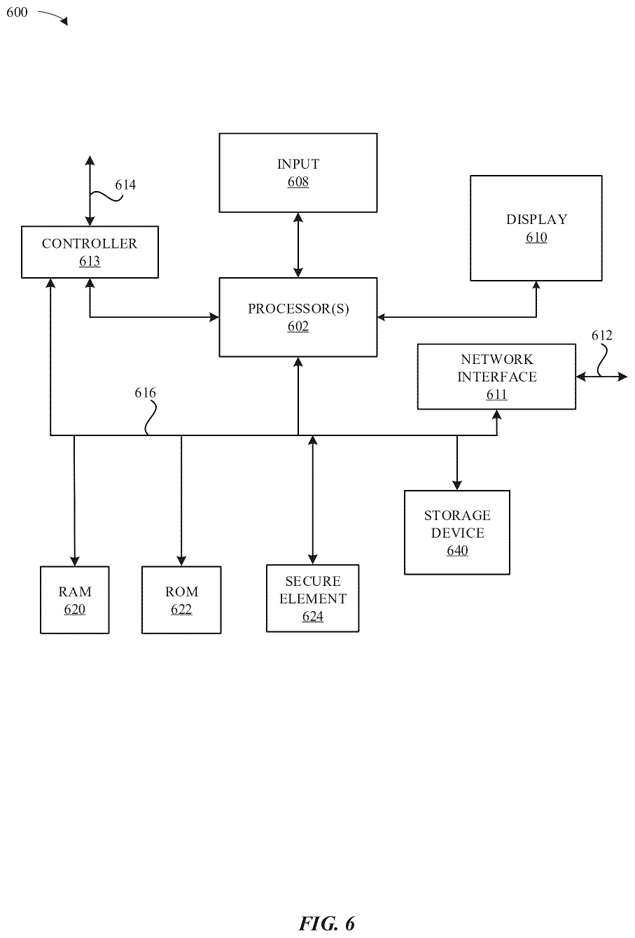

FIG. 6 illustrates in block diagram format an exemplary computing device 600 that can be used to implement the various components and techniques described herein, according to some embodiments. In particular, the detailed view of the exemplary computing device 600 illustrates various components that can be included in the wireless device 102. As shown in FIG. 6, the computing device 600 can include one or more processors 602 that represent microprocessors or controllers for controlling the overall operation of computing device 600. In some embodiments, the computing device 600 can also include a user input device 608 that allows a user of the computing device 600 to interact with the computing device 600. For example, in some embodiments, the user input device 608 can take a variety of forms, such as a button, keypad, dial, touch screen, audio input interface, visual/image capture input interface, input in the form of sensor data, etc. In some embodiments, the computing device 600 can include a display 610 (screen display) that can be controlled by the processor(s) 602 to display information to the user (for example, information relating to incoming, outgoing, or active communication sessions). A data bus 616 can facilitate data transfer between at least a storage device 640, the processor(s) 602, and a controller 613. The controller 613 can be used to interface with and control different equipment through an equipment control bus 614. The computing device 600 can also include a network/bus interface 611 that couples to a data link 612. In the case of a wireless connection, the network/bus interface 611 can include wireless circuitry, such as a wireless transceiver and/or baseband component. The computing device 600 can also include a secure element 624. The secure element 624 can include an eUICC 108, an iUICC, and/or one or more UICCs 118.

The computing device 600 also includes a storage device 640, which can include a single storage or a plurality of storages (e.g., hard drives and/or solid-state drives), and includes a storage management module that manages one or more partitions within the storage device 640. In some embodiments, storage device 640 can include flash memory, semiconductor (solid state) memory or the like. The computing device 600 can also include a Random-Access Memory (RAM) 620 and a Read-Only Memory (ROM) 622. The ROM 622 can store programs, utilities or processes to be executed in a non-volatile manner. The RAM 620 can provide volatile data storage, and stores instructions related to the operation of the computing device 600.

### Wireless Terminology

In accordance with various embodiments described herein, the terms “wireless communication device,” “wireless device,” “mobile device,” “mobile station,” “mobile wireless device,” and “user equipment” (UE) may be used interchangeably herein to describe one or more consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near-field communication (NFC), a cellular wireless network, a fourth generation (4G) LTE, LTE Advanced (LTE-A), 5G, and/or 6G or other present or future developed advanced cellular wireless networks.

The wireless device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode user equipment (UE) can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE network or a 3G legacy network, e.g., an Evolved High Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method to adjust an uplink power limit, the method comprising:
by one or more processors of a wireless device:
determining a first uplink transmit power limit for a first transmit time interval that includes one or more uplink acknowledgements (ACKs) corresponding to received downlink data based on at least one regulatory power limit and excluding a non-regulatory device performance power limit;
determining a second uplink transmit power limit for a second transmit time interval that does not include an uplink ACK corresponding to received downlink data based on both the at least one regulatory power limit and the non-regulatory device performance power limit; and
configuring an uplink transmission for at least the first and second transmit time intervals in accordance with the determined first and second uplink transmit power limits.

2. The method of claim 1, further comprising:
determining an adverse uplink radio condition is impacting downlink data performance,
wherein determination of the first and second uplink transmit power limits and configuration of the uplink transmission in accordance with the determined first and second uplink transmit power limits occurs responsive to determination of the adverse uplink radio condition.

3. The method of claim 2, further comprising:
responsive to determination that the adverse uplink radio condition is no longer impacting downlink data performance, determining a third uplink transmit power limit for a third transmit time interval based on both the at least one regulatory power limit and the non-regulatory device performance power limit independent of whether the third transmit time interval includes uplink ACKs corresponding to received downlink data.

4. The method of claim 2, wherein:
determining the adverse uplink radio condition is impacting downlink data performance comprises detecting uplink performance does not satisfy an uplink performance threshold and downlink performance satisfies a downlink performance threshold.

5. The method of claim 4, wherein:
the uplink performance does not satisfy the uplink performance threshold when an uplink block error rate (BLER) exceeds an uplink BLER threshold.

6. The method of claim 2, wherein:
determining the adverse uplink radio condition is impacting downlink data performance comprises detecting operation in a far cell condition.

7. The method of claim 2, wherein:
determining the adverse uplink radio condition is impacting downlink data performance comprises detecting a radio link path loss value exceeding a radio link path loss threshold.

8. The method of claim 2, wherein:
determining the adverse uplink radio condition is impacting downlink data performance comprises detecting uplink power limited transmission.

9. The method of claim 2, wherein:
determining the adverse uplink radio condition is impacting downlink data performance comprises detecting operation using a radio frequency band having a specific absorption rate (SAR) limit below a SAR threshold.

10. The method of claim 1, wherein:
determination of the first uplink transmit power limit and the second uplink transmit power limit is further based on a device transmit hardware limit.

11. The method of claim 1, wherein:
determination of the first uplink transmit power limit and the second uplink transmit power limit is further based on a specific absorption rate (SAR) limit.

12. The method of claim 1, wherein:
determination of the first uplink transmit power limit and the second uplink transmit power limit is further based on a cellular wireless network specified transmit power limit.

13. An apparatus for adjusting an uplink power limit, the apparatus comprising one or more processors communicatively coupled to a memory storing instructions, the one or more processors configured to:
determine a first uplink transmit power limit for a first transmit time interval that includes one or more uplink acknowledgements (ACKs) corresponding to received downlink data based on at least one regulatory power limit and excluding a non-regulatory device performance power limit;
determine a second uplink transmit power limit for a second transmit time interval that does not include an uplink ACK corresponding to received downlink data based on both the at least one regulatory power limit and the non-regulatory device performance power limit; and
configure an uplink transmission for at least the first and second transmit time intervals in accordance with the determined first and second uplink transmit power limits.

14. The apparatus of claim 13, wherein the one or more processors are further configured to:
determine an adverse uplink radio condition is impacting downlink data performance,
wherein determination of the first and second uplink transmit power limits and configuration of the uplink transmission in accordance with the determined first and second uplink transmit power limits occurs responsive to determination of the adverse uplink radio condition.

15. The apparatus of claim 14, wherein the one or more processors are further configured to:
responsive to determination that the adverse uplink radio condition is no longer impacting downlink data performance, determine a third uplink transmit power limit for a third transmit time interval based on both the at least one regulatory power limit and the non-regulatory device performance power limit independent of whether the third transmit time interval includes uplink ACKs corresponding to received downlink data.

16. The apparatus of claim 14, wherein:
determination of the adverse uplink radio condition is impacting downlink data performance comprises detecting uplink performance does not satisfy an uplink performance threshold and downlink performance satisfies a downlink performance threshold.

17. The apparatus of claim 16, wherein:
the uplink performance does not satisfy the uplink performance threshold when an uplink block error rate (BLER) exceeds an uplink BLER threshold.

18. The apparatus of claim 14, wherein determination that the adverse uplink radio condition is impacting downlink data performance comprises:
detecting operation in a far cell condition;
detecting a radio link path loss value exceeding a radio link path loss threshold;
detecting uplink power limited transmission;
detecting operation using a radio frequency band having a specific absorption rate (SAR) limit below a SAR threshold; or
any combination thereof.

19. The apparatus of claim 13, wherein determination of the first uplink transmit power limit and the second uplink transmit power limit is further based on:
a device transmit hardware limit;
a specific absorption rate (SAR) limit;
a cellular wireless network specified transmit power limit; or
any combination thereof.

20. A non-transitory computer-readable medium storing instructions for adjusting an uplink power limit, the instructions comprising:
instructions for determining a first uplink transmit power limit for a first transmit time interval that includes one or more uplink acknowledgements (ACKs) corresponding to received downlink data based on at least one regulatory power limit and excluding a non-regulatory device performance power limit;
instructions for determining a second uplink transmit power limit for a second transmit time interval that does not include an uplink ACK corresponding to received downlink data based on both the at least one regulatory power limit and the non-regulatory device performance power limit; and
instructions for configuring an uplink transmission for at least the first and second transmit time intervals in accordance with the determined first and second uplink transmit power limits.
